(19) United States
(12) Patent Application Publication
(10) Pub. No.: US 2026/0289206 A1
(43) Pub. Date: Sep. 24, 2026

(54) METHODS AND APPARATUSES RELATING TO ACTIVATION SIGNALS FOR TAG DEVICES

(71) Applicant: Nokia Technologies Oy, Espoo (FI)

(72) Inventors: Simon SVENDSEN, Aalborg (DK); Oana-Elena BARBU, Aalborg (DK); Johannes HARREBEK, Aalborg (DK); Benny VEJLGAARD, Gistrup (DK)

(21) Appl. No.: 19/475,527

(22) PCT Filed: Apr. 21, 2023
(86) PCT No.: PCT/EP2023/060443

§ 371 Date: Oct. 15, 2025

(51) Int. Cl. G06K 7/10; G06K 19/07; G06K 19/073

(52) U.S. Cl. CPC G06K 7/10475; G06K 7/10158; G06K 7/10257; G06K 19/0709; G06K 19/07309

(57) ABSTRACT

This specification describes a tag device comprising: means for receiving a series of activation signals, each comprising a charging portion for charging the tag device, a backscatter portion for backscattering by the tag device and a security portion between the charging portion and the backscattering portion modulated to carry a respective code; means for detecting the codes carried by the activation signals; means for comparing the detected codes with codes of a predetermined sequence of codes that is stored at the tag device; means for refraining from backscattering information in response to the activation signals until a subsequence of n consecutive codes from the predetermined sequence of codes has been detected in the series of activation signals, wherein n is at least two; and means for, in response to a determination that a subsequence of n consecutive codes from the predetermined sequence of codes has been detected in the series of activation signals, backscattering information related to the tag device using the backscatter portion of an activation signal of the series of activation signals in which the nth of the n consecutive codes is detected.

### FIELD

This specification relates to activation signals for tag devices

### BACKGROUND

A tag device is a device that harnesses energy from received wireless signals (and in some instances other ambient energy sources such as solar or kinetic energy) and charges a circuitry that, once activated, may cause a signal which encodes information related to the tag device, such as a device ID, to be emitted (this is also referred to as reflection or back-scattering). Such devices have many potential applications within the “Internet of Things” (IoT).

3GPP has specified NB-IoT/eMTC (in Release 13) and NR RedCap (in Release 17) to satisfy requirements on low cost and low power devices for wide area IoT communication. Existing IoT devices operating based on these standards usually consume tens or hundreds of milliwatts power while transmitting/receiving, and only cost a few dollars. However, to achieve the “internet of everything”, IoT devices with ten or even a hundred times lower cost and power consumption may be needed, especially for the many possible applications that would benefit from, or even be enabled by, battery-less devices.

### SUMMARY

In a first aspect, this specification describes a tag device comprising: means for receiving a series of activation signals, each comprising a charging portion for charging the tag device, a backscatter portion for backscattering by the tag device and a security portion between the charging portion and the backscattering portion modulated to carry a respective code; means for detecting the codes carried by the activation signals; means for comparing the detected codes with codes of a predetermined sequence of codes that is stored at the tag device; means for refraining from backscattering information in response to the activation signals until a subsequence of n consecutive codes from the predetermined sequence of codes has been detected in the series of activation signals, wherein n is at least two; and means for, in response to a determination that a subsequence of n consecutive codes from the predetermined sequence of codes has been detected in the series of activation signals, backscattering information related to the tag device using the backscatter portion of an activation signal of the series of activation signals in which the nth of the n consecutive codes is detected.

In some examples, n may be equal to two, and the series of activation signals may comprise at least a first activation signal and a second activation signal. In such examples, the tag device may comprise: a first memory portion for storing an identifier of a most-recently detected code that corresponds to a code in the predetermined sequence of codes; and means for, upon receiving the first activation signal and determining that a code detected in the first activation signal corresponds to a first code of the predetermined sequence of codes, storing an identifier of the first code in the first memory portion. The tag device may further comprise means for, upon receiving the second activation signal, examining the first memory portion to determine the identifier stored therein; means for determining whether a code detected in the second activation signal corresponds to a second code in the predetermined sequence of codes that, in the predetermined sequence of codes, immediately follows the first code, the identifier of which is stored in the first memory portion; and means for, in response to a determination that the code detected in the second activation signal corresponds to a second code in the predetermined sequence of codes that, in the predetermined sequence of codes, immediately follows the first code, backscattering information related to the tag device using the backscatter portion of the second activation signal. In some examples, the tag device may comprise: means for determining whether the first code is at a position in the predetermined sequence that is after a position of a code that is currently identified in the first memory portion or is at a position in the predetermined sequence that is at least a predefined number of positions before the position of the code that is currently identified in the first memory portion; means for updating the first memory portion to store the identifier of the first code in response to determining that the first code is at a position in the predetermined sequence that is after the position of the code that is currently identified in the first memory portion or is at a position in the predetermined sequence that is at least the predefined number of positions before the position of the code that is currently identified in the first memory portion; and means for disregarding the code carried in the first activation signal in response to determining that the first code is not at a position in the predetermined sequence that is after the position of the code that is currently identified in the first memory portion and is not at a position in the predetermined sequence that is at least the predefined number of positions before the position of the code that is currently identified in the first memory portion.

The tag device may further comprise means for updating the first memory portion to store an identifier of the second code and, in some examples, may further comprise: means for receiving a third activation signal of the series of activation signals; means for examining the first memory portion to determine the identifier stored therein and determining whether a code detected in the third activation signal corresponds to a third code in the predetermined sequence of codes that, in the predetermined sequence of codes, immediately follows the second code, the identifier of which is stored in the first memory portion; and means for backscattering information related to the tag device responsive to determining that the code detected in the third activation signal corresponds to a third code in the predetermined sequence of codes that, in the predetermined sequence, immediately follows the second code.

In some examples, the tag device comprises: means for, upon receiving the second activation signal, examining the first memory portion to determine the identifier stored therein; means for determining whether a code detected in the second activation signal corresponds to a second code in the predetermined sequence of codes that, in the predetermined sequence, immediately follows the first code, the identifier of which is stored in the first memory portion; and means for refraining from backscattering information in response to determining that the code detected in the second activation signal does not correspond to a second code in the predetermined sequence of codes that, in the predetermined sequence of codes, immediately follows the first code.

In some examples, the tag device may comprise: a second memory portion for recording, for each of multiple codes in the predetermined sequence of codes, a counter having a value indicating a number of codes from the sequence of codes that have been detected by the tag device since that code was previously detected, wherein the backscattering of information related to the tag device is performed in response to determining a) that a counter for the second code indicates that the second code has not been previously detected by the tag device, or b) that the value of the counter for the second code is in excess of a predetermined threshold.

The activation signals of the series of activation signals may include a synchronisation portion between the charging portion and the security portion modulated to carry a synchronisation code. In such examples, the tag device may further comprise, in respect of each activation signal: means for detecting the synchronisation code, and means for detecting a start of the security portion based on detection of the synchronisation code. The tag device may further comprise means for determining, in respect of at least a first activation signal of the series of activation signals, a baud-rate based on the synchronisation code detected in the activation signal, and means for using the determined baud-rate when detecting the code in the security portion of the activation signal. The tag device may comprise means for receiving a first activation signal of the series of activations signals; and means for waiting for a pre-determined duration after the tag device is sufficiently charged by the energy of the charging portion of the first activation signal before monitoring for the synchronisation code carried in the first activation signal. The tag device may comprise means for receiving a first activation signal of the series of activation signals; and means for disregarding any codes received in the first activation signal before expiry of a pre-determined duration after the tag device is sufficiently charged by the energy of the charging portion of the first activation signal.

In a second aspect, this specification describes a method comprising: receiving, at a tag device, a series of activation signals, each comprising a charging portion for charging the tag device, a backscatter portion for backscattering by the tag device and a security portion between the charging portion and the backscattering portion modulated to carry a respective code; detecting, by the tag device, the codes carried by the activation signals; comparing, by the tag device, the detected codes with codes of a predetermined sequence of codes that is stored at the tag device; refraining, by the tag device, from backscattering information in response to the activation signals until a subsequence of n consecutive codes from the predetermined sequence of codes has been detected in the series of activation signals, wherein n is at least two; and, in response to a determination that a subsequence of n consecutive codes from the predetermined sequence of codes has been detected in the series of activation signals, backscattering, by the tag device, information related to the tag device using the backscatter portion of an activation signal of the series of activation signals in which the nth of the n consecutive codes is detected.

In some examples, n may be equal to two, and the series of activation signals may comprise at least a first activation signal and a second activation signal. In such examples, the method may comprise storing, in a first memory portion at the tag device, an identifier of a most-recently detected code that corresponds to a code in the predetermined sequence of codes; and, upon receiving the first activation signal and determining that a code detected in the first activation signal corresponds to a first code of the predetermined sequence of codes, storing an identifier of the first code in the first memory portion. The method may further comprise, upon receiving the second activation signal, examining the first memory portion to determine the identifier stored therein; determining whether a code detected in the second activation signal corresponds to a second code in the predetermined sequence of codes that, in the predetermined sequence of codes, immediately follows the first code, the identifier of which is stored in the first memory portion; and, in response to a determination that the code detected in the second activation signal corresponds to a second code in the predetermined sequence of codes that, in the predetermined sequence of codes, immediately follows the first code, backscattering information related to the tag device using the backscatter portion of the second activation signal. In some examples, the method may comprise: determining whether the first code is at a position in the predetermined sequence that is after a position of a code that is currently identified in the first memory portion or is at a position in the predetermined sequence that is at least a predefined number of positions before the position of the code that is currently identified in the first memory portion; updating the first memory portion to store the identifier of the first code in response to determining that the first code is at a position in the predetermined sequence that is after the position of the code that is currently identified in the first memory portion or is at a position in the predetermined sequence that is at least the predefined number of positions before the position of the code that is currently identified in the first memory portion; and disregarding the code carried in the first activation signal in response to determining that the first code is not at a position in the predetermined sequence that is after the position of the code that is currently identified in the first memory portion and is not at a position in the predetermined sequence that is at least the predefined number of positions before the position of the code that is currently identified in the first memory portion.

The method may further comprise updating the first memory portion to store an identifier of the second code and, in some examples, may further comprise receiving a third activation signal of the series of activation signals; examining the first memory portion to determine the identifier stored therein and determining whether a code detected in the third activation signal corresponds to a third code in the predetermined sequence of codes that, in the predetermined sequence of codes, immediately follows the second code, the identifier of which is stored in the first memory portion; and backscattering information related to the tag device responsive to determining that the code detected in the third activation signal corresponds to a third code in the predetermined sequence of codes that, in the predetermined sequence, immediately follows the second code.

In some examples, the method may comprise, upon receiving the second activation signal, examining the first memory portion to determine the identifier stored therein; determining whether a code detected in the second activation signal corresponds to a second code in the predetermined sequence of codes that, in the predetermined sequence, immediately follows the first code, the identifier of which is stored in the first memory portion; and refraining from backscattering information in response to determining that the code detected in the second activation signal does not correspond to a second code in the predetermined sequence of codes that, in the predetermined sequence of codes, immediately follows the first code.

In some examples, the method may comprise: recording, in a second memory portion at the tag device, for each of multiple codes in the predetermined sequence of codes, a counter having a value indicating a number of codes from the sequence of codes that have been detected by the tag device since that code was previously detected, wherein the backscattering of information related to the tag device is performed in response to determining a) that a counter for the second code indicates that the second code has not been previously detected by the tag device, or b) that the value of the counter for the second code is in excess of a predetermined threshold.

The activation signals of the series of activation signals may include a synchronisation portion between the charging portion and the security portion modulated to carry a synchronisation code. In such examples, the method may further comprise, in respect of each activation signal: detecting the synchronisation code, and detecting a start of the security portion based on detection of the synchronisation code. The method may further comprise determining, in respect of at least a first activation signal of the series of activation signals, a baud-rate based on the synchronisation code detected in the activation signal, and using the determined baud-rate when detecting the code in the security portion of the activation signal. The method may comprise receiving a first activation signal of the series of activations signals; and waiting for a pre-determined duration after the tag device is sufficiently charged by the energy of the charging portion of the first activation signal before monitoring for the synchronisation code carried in the first activation signal. The method may comprise receiving a first activation signal of the series of activation signals; and disregarding any codes received in the first activation signal before expiry of a pre-determined duration after the tag device is sufficiently charged by the energy of the charging portion of the first activation signal.

In a third aspect, this specification describes apparatus (e.g. a tag device or a component of a tag device) comprising at least one processor and at least one memory storing instructions that, when executed by the at least one processor, cause the apparatus at least to perform: receiving, at a tag device, a series of activation signals, each comprising a charging portion for charging the tag device, a backscatter portion for backscattering by the tag device and a security portion between the charging portion and the backscattering portion modulated to carry a respective code; detecting, by the tag device, the codes carried by the activation signals; comparing, by the tag device, the detected codes with codes of a predetermined sequence of codes that is stored at the tag device; refraining, by the tag device, from backscattering information in response to the activation signals until a subsequence of n consecutive codes from the predetermined sequence of codes has been detected in the series of activation signals, wherein n is at least two; and, in response to a determination that a subsequence of n consecutive codes from the predetermined sequence of codes has been detected in the series of activation signals, backscattering, by the tag device, information related to the tag device using the backscatter portion of an activation signal of the series of activation signals in which the nth of the n consecutive codes is detected.

In some examples, n may be equal to two, and the series of activation signals may comprise at least a first activation signal and a second activation signal. In such examples, the instructions may, when executed by the at least one processor, cause the apparatus to perform: storing, in a first memory portion at the tag device, an identifier of a most-recently detected code that corresponds to a code in the predetermined sequence of codes; and, upon receiving the first activation signal and determining that a code detected in the first activation signal corresponds to a first code of the predetermined sequence of codes, storing an identifier of the first code in the first memory portion. The instructions may, when executed by the at least one processor, cause the apparatus to perform: upon receiving the second activation signal, examining the first memory portion to determine the identifier stored therein; determining whether a code detected in the second activation signal corresponds to a second code in the predetermined sequence of codes that, in the predetermined sequence of codes, immediately follows the first code, the identifier of which is stored in the first memory portion; and, in response to a determination that the code detected in the second activation signal corresponds to a second code in the predetermined sequence of codes that, in the predetermined sequence of codes, immediately follows the first code, backscattering information related to the tag device using the backscatter portion of the second activation signal. In some examples, the instructions may, when executed by the at least one processor, cause the apparatus to perform: determining whether the first code is at a position in the predetermined sequence that is after a position of a code that is currently identified in the first memory portion or is at a position in the predetermined sequence that is at least a predefined number of positions before the position of the code that is currently identified in the first memory portion; updating the first memory portion to store the identifier of the first code in response to determining that the first code is at a position in the predetermined sequence that is after the position of the code that is currently identified in the first memory portion or is at a position in the predetermined sequence that is at least the predefined number of positions before the position of the code that is currently identified in the first memory portion; and disregarding the code carried in the first activation signal in response to determining that the first code is not at a position in the predetermined sequence that is after the position of the code that is currently identified in the first memory portion and is not at a position in the predetermined sequence that is at least the predefined number of positions before the position of the code that is currently identified in the first memory portion.

The instructions may, when executed by the at least one processor, cause the apparatus to perform: updating the first memory portion to store an identifier of the second code and, in some examples, may further comprise receiving a third activation signal of the series of activation signals; examining the first memory portion to determine the identifier stored therein and determining whether a code detected in the third activation signal corresponds to a third code in the predetermined sequence of codes that, in the predetermined sequence of codes, immediately follows the second code, the identifier of which is stored in the first memory portion; and backscattering information related to the tag device responsive to determining that the code detected in the third activation signal corresponds to a third code in the predetermined sequence of codes that, in the predetermined sequence, immediately follows the second code.

The instructions may, when executed by the at least one processor, cause the apparatus to perform: upon receiving the second activation signal, examining the first memory portion to determine the identifier stored therein; determining whether a code detected in the second activation signal corresponds to a second code in the predetermined sequence of codes that, in the predetermined sequence, immediately follows the first code, the identifier of which is stored in the first memory portion; and refraining from backscattering information in response to determining that the code detected in the second activation signal does not correspond to a second code in the predetermined sequence of codes that, in the predetermined sequence of codes, immediately follows the first code.

The instructions may, when executed by the at least one processor, cause the apparatus to perform: recording, in a second memory portion at the tag device, for each of multiple codes in the predetermined sequence of codes, a counter having a value indicating a number of codes from the sequence of codes that have been detected by the tag device since that code was previously detected, wherein the backscattering of information related to the tag device is performed in response to determining a) that a counter for the second code indicates that the second code has not been previously detected by the tag device, or b) that the value of the counter for the second code is in excess of a predetermined threshold.

The activation signals of the series of activation signals may include a synchronisation portion between the charging portion and the security portion modulated to carry a synchronisation code. In such examples, the instructions may, when executed by the at least one processor, cause the apparatus to perform, in respect of each activation signal: detecting the synchronisation code, and detecting a start of the security portion based on detection of the synchronisation code. The instructions may, when executed by the at least one processor, cause the apparatus to perform: determining, in respect of at least a first activation signal of the series of activation signals, a baud-rate based on the synchronisation code detected in the activation signal, and using the determined baud-rate when detecting the code in the security portion of the activation signal. The instructions may, when executed by the at least one processor, cause the apparatus to perform: receiving a first activation signal of the series of activations signals; and waiting for a pre-determined duration after the tag device is sufficiently charged by the energy of the charging portion of the first activation signal before monitoring for the synchronisation code carried in the first activation signal. The instructions may, when executed by the at least one processor, cause the apparatus to perform: receiving a first activation signal of the series of activation signals; and disregarding any codes received in the first activation signal before expiry of a pre-determined duration after the tag device is sufficiently charged by the energy of the charging portion of the first activation signal.

In a fourth aspect, this specification describes an activator device comprising: means for transmitting at least a first activation signal and a second activation signal, the first activation signal comprising a first charging portion for charging a tag device, a first backscatter portion for backscattering by the tag device and a first security portion between the first charging portion and the first backscatter portion modulated to carry a first code for detection by the tag device, the second activation signal comprising a second charging portion for charging the tag device, a second backscatter portion for backscattering by the tag device and a second security portion between the second charging portion and the second backscatter portion modulated to carry a second code for detection by the tag device, wherein the second code immediately follows the first code in a predetermined sequence of codes that is stored at the tag device.

The activator device may comprise means for receiving, from a session control entity and prior to transmission of the first activation signal, configuration information indicative of the first and second codes. The configuration information may include at least a portion of the predetermined sequence of codes which includes the first code and the second code, or the predetermined sequence of codes.

The first activation signal may further comprise a first synchronisation portion between the first charging portion and the first security portion, and the second activation signal comprises a second synchronisation portion between the second charging portion and the second security portion, wherein the first synchronisation portion and the second synchronisation portion are each modulated to convey the same synchronisation code for detection by the tag device.

In a fifth aspect, this specification describes a method comprising: transmitting, by an activator device, at least a first activation signal and a second activation signal, the first activation signal comprising a first charging portion for charging a tag device, a first backscatter portion for backscattering by the tag device and a first security portion between the first charging portion and the first backscatter portion modulated to carry a first code for detection by the tag device, the second activation signal comprising a second charging portion for charging the tag device, a second backscatter portion for backscattering by the tag device and a second security portion between the second charging portion and the second backscatter portion modulated to carry a second code for detection by the tag device, wherein the second code immediately follows the first code in a predetermined sequence of codes that is stored at the tag device.

The method may comprise receiving, from a session control entity and prior to transmission of the first activation signal, configuration information indicative of the first and second codes. The configuration information may include at least a portion of the predetermined sequence of codes which includes the first code and the second code, or the predetermined sequence of codes.

The first activation signal may further comprise a first synchronisation portion between the first charging portion and the first security portion, and the second activation signal comprises a second synchronisation portion between the second charging portion and the second security portion, wherein the first synchronisation portion and the second synchronisation portion are each modulated to convey the same synchronisation code for detection by the tag device.

In a sixth aspect, this specification describes apparatus (e.g. an activator device or a component of an activator device) comprising at least one processor and at least one memory storing instructions that, when executed by the at least one processor, cause the apparatus at least to perform: transmitting, by an activator device, at least a first activation signal and a second activation signal, the first activation signal comprising a first charging portion for charging a tag device, a first backscatter portion for backscattering by the tag device and a first security portion between the first charging portion and the first backscatter portion modulated to carry a first code for detection by the tag device, the second activation signal comprising a second charging portion for charging the tag device, a second backscatter portion for backscattering by the tag device and a second security portion between the second charging portion and the second backscatter portion modulated to carry a second code for detection by the tag device, wherein the second code immediately follows the first code in a predetermined sequence of codes that is stored at the tag device.

The instructions may, when executed by the at least one processor, cause the apparatus to perform receiving, from a session control entity and prior to transmission of the first activation signal, configuration information indicative of the first and second codes. The configuration information may include at least a portion of the predetermined sequence of codes which includes the first code and the second code, or the predetermined sequence of codes.

The first activation signal may further comprise a first synchronisation portion between the first charging portion and the first security portion, and the second activation signal comprises a second synchronisation portion between the second charging portion and the second security portion, wherein the first synchronisation portion and the second synchronisation portion are each modulated to convey the same synchronisation code for detection by the tag device.

In a seventh aspect, this specification describes a session control entity comprising means for transmitting to an activator device configuration information indicative of: a first code that is to be modulated on to a first security portion of a first activation signal that is to be transmitted by the activator device to a tag device; and a second code that is to be modulated on to a second security portion of a second activation signal that is to be transmitted by the activator device to the tag device, wherein the second code immediately follows the first code in a predetermined sequence of codes that is stored at the tag device.

The session control entity may further comprise: means for determining that an acknowledgment timer has expired prior to receipt by the session control entity of an acknowledgement that a backscattered signal has been received from the tag device; and means for transmitting to the activator device, in response to a determination that the acknowledgment timer has expired prior to receipt by the session control entity of an acknowledgement that the backscattered signal has been received from the tag device, a message which indicates that the first code is to be carried in a third security portion of a third activation signal that is to be transmitted by the activator device to the tag device. The session control entity may further comprise: means for determining that an acknowledgment timer has expired prior to receipt by the session control entity of an acknowledgement that a backscattered signal has been received from the tag device; and means for transmitting to the activator device, in response to a determination that the acknowledgment timer has expired prior to receipt by the session control entity of an acknowledgement that a backscattered signal has been received from the tag device, a message which indicates that the activator device should increase a power at which one or more subsequent activation signals are transmitted.

The session control entity may further comprise: means for determining that an acknowledgment timer has expired prior to receipt by the session control entity of an acknowledgement that a backscattered signal was received from the tag device; and means for activating an additional reader device configured to detect signals backscattered by the tag device and/or for activating an additional activator device configured to transmit activation signals for detection by the tag device.

In an eighth aspect, this specification describes a method comprising transmitting, by a session control entity and to an activator device, configuration information indicative of: a first code that is to be modulated on to a first security portion of a first activation signal that is to be transmitted by the activator device to a tag device; and a second code that is to be modulated on to a second security portion of a second activation signal that is to be transmitted by the activator device to the tag device, wherein the second code immediately follows the first code in a predetermined sequence of codes that is stored at the tag device.

The method may further comprise: determining that an acknowledgment timer has expired prior to receipt by the session control entity of an acknowledgement that a backscattered signal has been received from the tag device; and transmitting to the activator device, in response to a determination that the acknowledgment timer has expired prior to receipt by the session control entity of an acknowledgement that the backscattered signal has been received from the tag device, a message which indicates that the first code is to be carried in a third security portion of a third activation signal that is to be transmitted by the activator device to the tag device. The method may further comprise: determining that an acknowledgment timer has expired prior to receipt by the session control entity of an acknowledgement that a backscattered signal has been received from the tag device; and transmitting, by the session control entity and to the activator device, in response to a determination that the acknowledgment timer has expired prior to receipt by the session control entity of an acknowledgement that a backscattered signal has been received from the tag device, a message which indicates that the activator device should increase a power at which one or more subsequent activation signals are transmitted.

The method may further comprise: determining that an acknowledgment timer has expired prior to receipt by the session control entity of an acknowledgement that a backscattered signal was received from the tag device; and activating an additional reader device configured to detect signals backscattered by the tag device and/or activating an additional activator device configured to transmit activation signals for detection by the tag device.

In a ninth aspect, this specification describes apparatus (e.g. a session control entity or a component of a session control entity) comprising at least one processor and at least one memory storing instructions that, when executed by the at least one processor, cause the apparatus at least to perform: transmitting, by a session control entity and to an activator device, configuration information indicative of: a first code that is to be modulated on to a first security portion of a first activation signal that is to be transmitted by the activator device to a tag device; and a second code that is to be modulated on to a second security portion of a second activation signal that is to be transmitted by the activator device to the tag device, wherein the second code immediately follows the first code in a predetermined sequence of codes that is stored at the tag device.

The instructions may, when executed by the at least one processor, cause the apparatus to perform: determining that an acknowledgment timer has expired prior to receipt by the session control entity of an acknowledgement that a backscattered signal has been received from the tag device; and transmitting to the activator device, in response to a determination that the acknowledgment timer has expired prior to receipt by the session control entity of an acknowledgement that the backscattered signal has been received from the tag device, a message which indicates that the first code is to be carried in a third security portion of a third activation signal that is to be transmitted by the activator device to the tag device. The instructions may, when executed by the at least one processor, cause the apparatus to perform: determining that an acknowledgment timer has expired prior to receipt by the session control entity of an acknowledgement that a backscattered signal has been received from the tag device; and transmitting, by the session control entity and to the activator device, in response to a determination that the acknowledgment timer has expired prior to receipt by the session control entity of an acknowledgement that a backscattered signal has been received from the tag device, a message which indicates that the activator device should increase a power at which one or more subsequent activation signals are transmitted.

The instructions may, when executed by the at least one processor, cause the apparatus to perform: determining that an acknowledgment timer has expired prior to receipt by the session control entity of an acknowledgement that a backscattered signal was received from the tag device; and activating an additional reader device configured to detect signals backscattered by the tag device and/or activating an additional activator device configured to transmit activation signals for detection by the tag device.

In a tenth aspect, this specification describes a non-transitory computer readable medium comprising program instructions stored thereon for causing performance of any of the operations described with reference to any of the first to ninth aspects, and not least the method of the second, fifth and eighth aspects.

In an eleventh aspect, this specification describes a computer program comprising instructions which, when executed, cause performance of any of the operations described with reference to any of the first to ninth aspects, and not least the method of the second, fifth and eighth aspects.

### BRIEF DESCRIPTION OF THE FIGURES

For better understanding of the present application, reference will now be made by way of example to the accompanying drawings in which:

FIG. 1 illustrates an example architecture in which one or more tag devices may be utilised;

FIG. 2 is a flow chart illustrating various operations that may be performed by a tag device;

FIG. 3 depicts an example of a sequence of codes which may be stored in a tag device according to techniques described herein;

FIG. 4 is a schematic example of a format of activation signals that may utilised within the techniques described herein;

FIG. 5 is an example message flow sequence that may take place within the architecture of FIG. 1;

FIG. 6 depicts operations that may be performed by a session control entity in various implementations of the techniques described herein;

FIG. 7 depicts operations that may be performed by an activator device in various implementations of the techniques described herein;

FIG. 8 is a schematic illustration of components which may be present in an activator device;

FIG. 9 is a schematic illustration of components which may be present in a session control entity;

FIG. 10 is a schematic illustration of components which may be present in a tag device; and

FIG. 11 is an illustration of a computer-readable medium.

### DETAILED DESCRIPTION

In the description and drawings below, like reference numerals refer to like elements throughout.

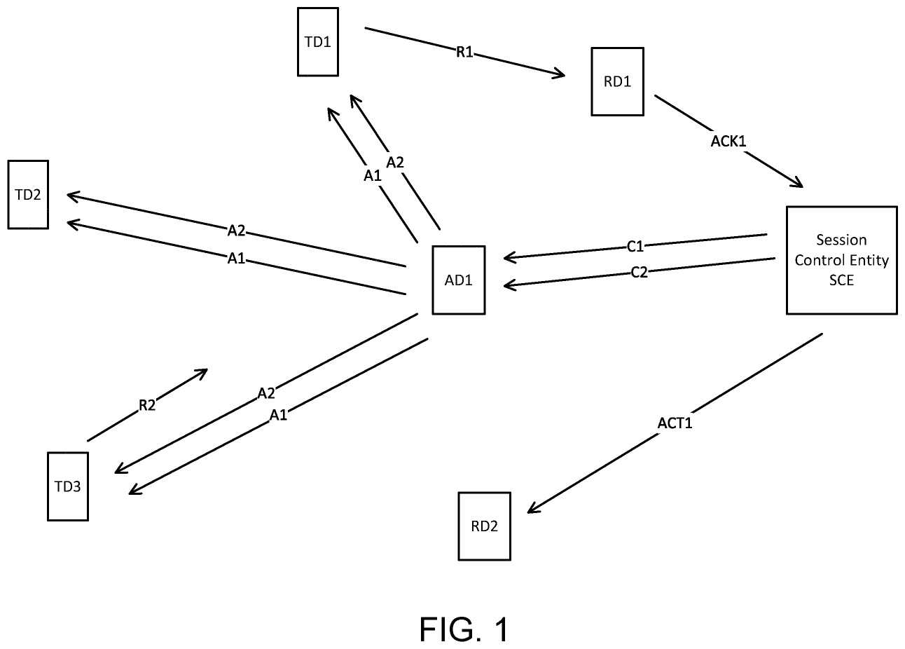

FIG. 1 illustrates an example architecture in which one or more tag devices TD1, TD2, TD3 may be utilised. The architecture, which may be referred to as a passive radio network, includes at least one activator device AD1, at least one tag device TD1, TD2, TD3 and at least one reader device RD1, RD2.

An activator device AD1 is a device that is configured to send one or more activation signals A1, A2 targeted at waking up one or more tag devices TD1, TD2, TD3 in the environment. A tag device TD1, TD2, TD3 is a device that is configured to harvest energy from the activation signals A1, A2 and to emit, reflect, or backscatter a responsive signal R1, R2 which includes information related to the tag device. A reader device RD1, RD2 is a device that is configured to listen for and to detect signals R1, R2 backscattered by tag devices TD1, TD2, TD3. The reader device may or may not be combined with or otherwise collocated with the activator device AD1.

In new radio NR communications, authentication and confidentiality of devices and signals are ensured by higher layer protocols which rely on cryptography. Such authentication, confidentiality and cryptography are well studied in the literature and solutions with various degrees of complexity are available. Many of the solutions are based on symmetric-key tag devices, where some of those require that the tag devices are implemented with Electrically-Erasable Programmable Read-Only Memory (EEPROM), which is re-writable memory that retains data even when the device is powered down, and Read Only Memory (ROM) for hard coded data. In addition, many of the solutions rely on a feedback loop between a back-end database server, the reader device and the tag device to communicate and validate IDs/codes. Therefore, even the most basic of these solutions may require the tag devices to utilise more energy than is available from purely ambient energy sources (which includes activation signals). For instance, the cryptographic operations for securing the communication link may require more energy than is available from the environment or may limit the amount of energy remaining at the tag device such that the risk that the tag device is not heard by the reader device is increased.

The techniques described in this specification may provide a security solution that may be employed by tag devices that utilise only ambient energy. Such tag devices, which may be referred to as “tags” or passive radio devices, may include pure batteryless devices with no energy storage capability that are completely dependent on the availability of ambient energy sources that can be harvested from the environment, and also devices with energy storage capability (e.g. up to that available from ambient sources via energy harvesting) but which do not need to be replaced or recharged manually, and which can manage short periods of ambient energy unavailability. In some embodiments, the tag devices may include a power supply but may still utilise the techniques described therein.

More specifically, the techniques described in this specification employ physical layer security method that may enable a basic authentication level. That is, the tag devices TD1, TD2, TD3 described herein may be configured, together with the activator devices A1, such that the tag devices TD1, TD2, TD3 respond only to activation signals (or queries) generated by legitimate activator devices (which may also be referred to as illuminator devices). Put another way, this specification describes techniques which may protect tag devices against malicious devices which would a) attempt to read the tag devices and gain access to the data stored thereon or b) simply obtain knowledge of existence of the tag device an environment. In addition, techniques described herein may enable selective activation of one or multiple tag devices.

FIG. 1 shows a first tag device TD1, a second tag device TD2, and a third tag device TD3 in an environment. The tag devices TD1, TD2, TD3 store a sequence of codes. Each of the tag devices may store the same sequence of codes or different ones of the tag devices may store different sequences of codes. For instance, each tag device may store a different sequence of codes, or a group of tag devices, e.g. TD1 and TD3 may store the same sequence of codes, but other tag devices e.g. TD2 may store a different sequence of codes.

An activator device AD1 in the environment may be configured to transmit (e.g. broadcast) a series of multiple activation signals A1, A2 which may be detected by one or more of the tag devices TD1, TD2, TD3 in the environment. The series of activation signals may be transmitted in bursts. In such examples, the activation signals in each burst may be transmitted in close succession, with a break before transmission of a next burst of further activation signals. Depending on at least the configuration of the activation signals and the timings of the activation signals within a burst, and, in some examples, energy storage capabilities of the tag devices, the initial (or first-transmitted) activation signal of a burst of activation signals may “wake-up” or “activate” the tag devices . The tag devices may then remain activated for the remainder of the burst. After the burst is complete, the tag devices may then become inactive. In other examples, the tag devices may be “woken-up” by each activation signal and be inactive between activation signals, regardless of whether or not the activation signals are transmitted in bursts.

In the example of FIG. 1, a series of two activation signals (first and second activation signals A1, A2) is transmitted by the activator device AD1. The first activation signal A1 is transmitted at a first point in time and the second activation signal A2 is transmitted at a second, later point in time. In the example of FIG. 1, each of the activation signals is received by each of the tag devices TD1, TD2, and TD3.

As explained below, the activator device AD1 may, in some examples, operate under the control of a session control entity SCE. For instance, the session control entity may configure, to some extent, the activation signals A1, A2 that are to be transmitted by the activator device AD1. The session control entity SCE may be or may reside at a telecommunications network entity such as a backbone Server, a location management function (LMF), or a base station such as a gNB. In other examples, the function of the session control entity may be provided by an activator device, a reader device or another device that is part of a passive radio network. The activator device AD1 may be any suitable device, for instance, a terminal device, such as a user equipment UE, a base station (e.g. gNB or a FWA base station). The reader device(s) RD1, RD2 may also be any suitable device and may, in some implementations be combined with or otherwise co-located with the activator device AD1.

According to aspects described herein, each of the activation signals A1, A2 comprises a charging portion for charging the tag device followed by a security portion that is modulated to carry a code (sometimes referred to herein as a “unique code” or a “security code”), which is followed by a backscatter portion, which the tag devices may use to backscatter information. The charging portion of the first activation signal A1 may be referred to as the first charging portion and the charging portion of the second activation signal A2 may be referred to as the second charging portion. The security portion of the first activation signal A1 may be referred to as the first security portion and the security portion of the second activation signal A2 may be referred to as the second security portion. The backscatter portion of the first activation signal A1 may be referred to as the first backscatter portion and the backscatter portion of the second activation signal A2 may be referred to as the backscatter security portion. Examples of the configuration of the activation signals A1, A2 are discussed in more detail below, particularly with reference to FIG. 4. For completeness, it is noted that the label “first” does not necessarily imply that first activation signal is the first activation signal ever transmitted by the activator device and/or received by the tag device. Similarly, the label “second” does not necessarily imply that there are no intervening activation signals transmitted by the activator device between transmission of the first and second activation signals. However, as described above, in the examples described herein, the second activation signal is transmitted after the first activation signal.

The tag devices TD1, TD2, and TD3 are configured to receive the series of activation signals A1, A2, to detect the codes in each of the activation signals, and to compare the detected codes with the codes of the predetermined sequence of codes that is stored at the tag device. As explained in more detail below, the tags are configured to refrain from backscattering information in response to the activation signals until a subsequence of n consecutive codes from the predetermined sequence of codes has been detected in the series of activation signals, and to respond to a determination that a subsequence of n consecutive codes from the predetermined sequence of codes has been detected in the series of activation signals by backscattering (via signal R1 in FIG. 1) information related to the tag device (e.g., information that is stored at the tag device). The backscattering is performed using the backscatter portion of the activation signal of the series of activation signals in which the nth of the n consecutive codes is detected. In most of the examples described herein n is equal to two, and so the tag will refrain from backscattering until two consecutive codes in the sequence of codes have been received in the correct order. The correct order here means that the earlier code in the sequence of codes is received before the code that, according to the predetermined sequence, immediately follows the earlier code in the sequence. Furthermore, the tag will refrain from backscattering if any codes from the sequence are detected between the n consecutive codes. For instance, if a first code in the sequence is detected in an activation signal and then the next received activation signal carries the next code in the sequence, the device will (if n=2) respond by backscattering information. However, if, for instance, a first code in the sequence is detected, then e.g. a third code in the sequence, and then the second code in the sequence, the tag device will refrain from backscattering because consecutive codes, e.g. the first and second codes (or indeed second and third codes) were not detected consecutively and in the correct order.

Although in most of the examples described herein n=2, it will be appreciated that n may be 3 or more. For instance, the tag devices may be configured to backscatter information only if three consecutive codes are detected consecutively and in the correct order (e.g. the first code in the sequence, followed by the second code, followed by the third code).

The tag devices are configured to harvest the energy from the charging portion of a given received activation signal and may then use this harvested energy to detect the code in the security portion of the activation signal. The tag devices TD1, TD2, and TD3 may then determine whether the detected code is present in a sequence of codes that is stored at the tag device. The tag devices may then perform an action responsive to determining that the code is present in the sequence of codes stored at the device.

The particular action is dependent on whether or not the tag device has previously received a prior activation signal including another code that is present in the sequence of codes stored at the tag device. The tag device may include a first memory portion for storing identifiers of the one or more most-recently detected codes from the sequence of codes. The stored identifier may include the code itself or a reference to the code such as its index in the sequence of codes. The tag device may then examine this first memory portion when a received activation signal is determined to carry a code from the sequence of codes. If there is no identifier in the first memory portion, the tag device may store the identifier of the presently detected code in the memory portion but refrain from backscattering information. If there is an identifier in the first memory portion and the identified code immediately precedes, in the predetermined sequence of codes, the presently detected code, the tag device responds by backscattering information. The device may then update the identifier in the first memory portion with that of the presently detected code. Alternatively, if there is an identifier in the first memory portion but the identified code does not immediately precede, in the predetermined sequence of codes, the presently detected code from the sequence, the tag device will refrain from backscattering information. The tag device may however overwrite the identifier in the first memory portion with that of the presently-detected code, and may await the next activation signal.

As will of course be appreciated, if the tag device receives an activation signal which carries a code, but that code is not present in the sequence of codes, the tag device refrains from backscattering information and does not update the first memory portion.

As will be appreciated, the number of identifiers stored in the first memory portion may depend on n. For instance, if n=2, the first memory portion may store the identifier of only the most-recently received code from the sequence of codes, but if n=3, the first memory portion may store the two most recently received codes from the sequence of codes.

In the example of FIG. 1, the first activation signal A1 carries a first code in the sequence of codes stored by the first tag device TD1, and the second activation signal A2 carries the next code in the sequence of codes stored by the first tag device TD1. Accordingly, the first tag device TD1 backscatters a signal R1 including information related to the first tag device TD1. The backscattered information may be stored at, or programmed into, the tag device. The backscattered information may include but is not limited to the ID of the first tag device. Such information may then be detected by one or more of the reader devices RD1, RD2. As will be appreciated, in some implementations, any suitably configured reader device in the environment may detect the backscattered information.

In the example of FIG. 1, the first and third tag devices TD1, TD3 may be in a common group of devices and so may each store the same sequence of codes. As such, the first and third tag devices may respond to the second activation signal A2, by backscattering information for detection by a reader device positioned in the environment, in this case a first reader device, RD1. In some examples, and as illustrated in FIG. 1, the first reader device RD1 may respond to receipt of one or more signals from tag devices by sending an indication of receipt of such signals to the session control entity SCE. This indication may include the information carried in the backscattered signal. Such an indication is depicted as ACK1 in FIG. 1.

In the example of FIG. 1, the signal R1 backscattered by the first tag device TD1 is received by a first reader device RD1. However, the signal R2 backscattered by the third tag device TD3 is not received by the first reader device RD1 or any other configured reader devices. This may be, for instance, because all configured reader devices, including the first reader device RD1, are out of range of the third tag device TD3. In such a situation, and as will be explained later, the session control entity SCE may activate or initialise one or more additional reader devices, e.g. a second reader device RD2, and/or activate or initialise one more or additional activator devices. This may increase the likelihood that a backscattered signal is detected from the third tag device TD3. Such activation may be performed via an activation signal ACT1 communicated from the session control entity. In FIG. 1, this activation signal is sent to the second reader device RD2.

In the example of FIG. 1, one or both of the first and second codes (as carried by the first and second activation signals respectively) may not be present in the sequence of codes stored at the second tag device TD2, or may not be consecutive in the sequence stored by the second tag device (or the second tag device may require more than two consecutive codes to be received before it will backscatter). As such, the second tag device TD2 does not backscatter a responsive signal for detection by a reader. The second tag device may thus not be in the same “group” as the first and second tag devices.

As will be discussed in more detail below, the session control entity may be configured to initialise the activator device AD1, and/or configure the activator device AD1 to transmit the first and second activation signals. Such configuration may be performed via one or more configuration messages C1, C2 communicated from the session control entity SCE to the activator device AD1.

For instance, the configuration messages C1, C2 may enable the activator device AD1 to identify the unique codes that are to be carried in the activation signals. In some examples, each activation signal A1, A2 may be configured by way of a respective configuration messages C1, C2. In some examples, the configuration messages may include the unique codes that are to be included in the activation signals. In some examples, the configuration messages may include the entire predetermined sequence of codes or a portion of the predetermined sequence of codes. For instance, the SCE may send a single configuration message including a portion of X codes from the sequence of codes. The activator device may then send X activation signals (for instance, in a burst), each with one of the X codes. After this, the activator device may be configured with another X codes from the sequence of codes

In other examples, the sequence of unique codes may be provided or indicated to the activator device AD1 as part of an initialisation process, and the codes to be included in the activation signals may be indicated via an identifier(s) (e.g. an index) included in one or more configuration signals C1, C2. For instance, during an initialisation process, the SCE may provide to the activator device AD1 a particular sequence of codes or may refer to a particular sequence of codes that is otherwise accessible to the activator device AD1. We will call this sequence of codes sequence A. Then, the configuration signals may simply indicate one or more of the codes in Sequence A rather than including the codes themselves. For instance, the configuration signal may indicate “code 5” meaning that the activator device A1 may should include the fifth code from sequence A in the activation signal. In some examples, the SCE could initialise the activator device with two pluralities of codes (e.g. sequence A and sequence B), each corresponding to a different group of tag devices. The configurations messages may then point to the sequence and the specific code, e.g. “sequence A, code 5” or “sequence B, code 3”.

In some other examples, a first one of the configuration messages C1 may include a particular sequence of codes or a portion thereof, and subsequent configuration messages may include pointers to codes of the previously-provided sequence (or portion thereof). In yet other examples, the SCE may provide or indicate a particular sequence of unique codes that is to be used by the activator device (e.g. in an initialisation message or a configuration message), and the activator device may then automatically use the codes in sequence without the need for further configuration messages. In such examples, the activator device AD1 may start from the beginning of the sequence, from a position in the plurality that is indicated by the SCE, or from a randomly (or quasi-randomly) selected position.

As will be appreciated from the discussion herein (not least that in respect of FIG. 1), by modulating a portion of the activation signal with the code, the techniques described herein may provide a degree of security without the need for synchronization between the activator device AD1 and the tag devices TD1, TD2, TD3. In addition, because the codes included in the activation signals can be used activate specific tag devices or specific groups of tag devices, interference from other tags may be reduced. Thus, interference cancellation that is required by the reader devices may be reduced. In addition, whereas a conventional tag device may start backscattering as soon as it has harvested sufficient energy (and so different tags may backscatter at different times), the techniques described herein may allow all tags their perform their back-scattering at the same time, synchronously after the detecting the codes.

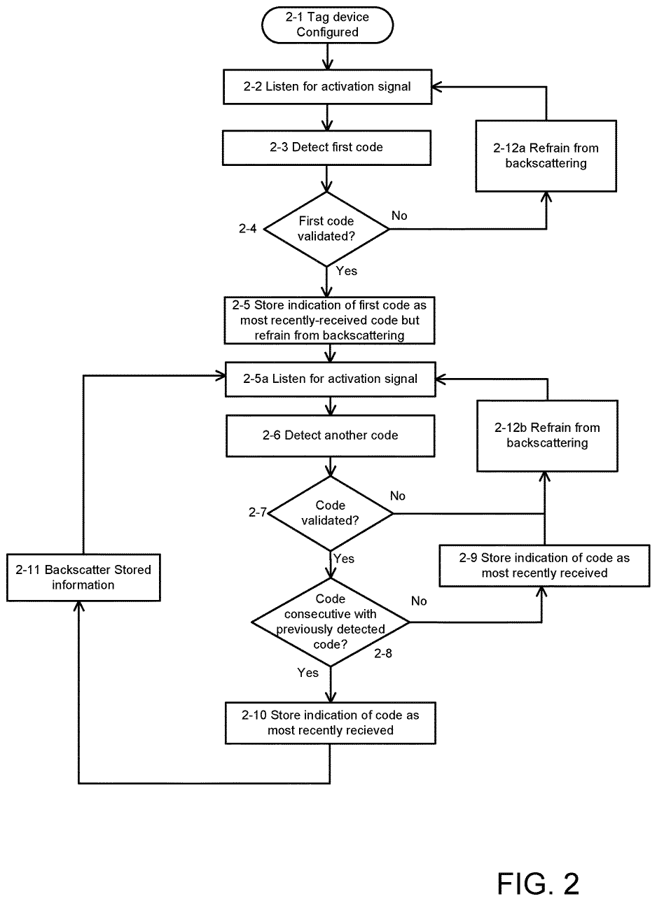

FIG. 2 is a flow chart illustrating various operations that may be performed by a tag device TD1, TD2, TD3 according to techniques described herein.

In operation 2-1, the tag device may be configured for use with the techniques described herein. For instance, the sequence of codes may be hard-coded into memory of the tag device.

In operation 2-2, the tag device listens for an activation signal. In addition, tag device may harvest energy from other RF signals in the environment.

In operation 2-3, having received the first activation signal A1 from the activator device AD1, the tag device TD1, TD2, TD3 may start charging using the charging portion of the first activation signal A1. Having harvested sufficient energy from the first activation signal, the tag device TD1, TD2, TD3 detects the first code in the first security portion of the first activation signal A1.

In operation 2-4, the tag device TD1, TD2, TD3 determines whether the detected first code is present in the sequence of codes stored at the tag device TD1, TD2, TD3. This may be referred to as validation of the first code. In some examples, in order to successfully validate the first code, as well as determining that the first code is present in the sequence of codes stored at the tag device TD1, TD2, TD3, the tag device may also need to verify that the first code has not been impermissibly re-used.

Verifying that a code has not been impermissibly re-used may involve recording how long ago that code was previously detected. For instance, the tag device may include a second memory portion for recording counters indicating how long ago codes were previously detected. Verifying that the code has not been impermissibly reused may comprise determining that a counter for that code has not yet been initialised or that the counter indicates a value that is in excess of some re-use threshold. For instance, in some examples, the second memory portion may store, for each code in the predetermined sequence of codes, a counter having a value indicating a number of codes from the sequence of codes that have detected by the tag device since that code was previously detected by the tag device. Specifically, after a code of the sequence is detected, the tag device may initialise the counter for that code and may also increment the counters for all codes that have previously been detected. Thus, the tag can determine how recently a particular code was last detected. In some examples, the second memory portion may not have dedicated counter for every code in the sequence but may have counters for the Y most recently received codes. For instance, when a code is received, that code may be assigned a counter, which is initialised (e.g. set to 1) and then incremented every time another code from the sequence is detected. The counter for that code may then be deleted, excised or the like, when it reaches the value Y. The space in the second memory portion may then assigned for a counter for the most-recently detected code. In this way, the memory requirements for the counter may be reduced.

In other examples, verifying that a newly-received code has not been impermissibly reused may include determining that the newly-received code has a particular positional relationship with a most-recently received valid (or validated) code, an identifier of which may be stored in the first memory portion. For instance, the particular positional relationship may be that the newly-received code is at a position in the sequence that is after (but not necessarily immediately after) the most-recently received valid code or is at a position in the sequence that is at least a predefined number of positions before the most-recently received valid code.

If the first code is successfully validated, the tag device may proceed to operation 2-5. If the first code cannot be validated (e.g. because the first code is not present in the sequence of codes stored at the tag device TD1, TD2, TD3, or the first code has been impermissibly reused), the tag device may proceed to operation 2-12a. In operation 2-12a, the tag device refrains from back-scattering. The tag device may also disregard the code in the first activation signal.

In operation 2-5, the tag device TD1, TD2, TD3 stores an identifier of the validated code in the first memory portion. As such, the tag device stores an identifier of the detected first code in the first memory portion. The stored identifier may be indicative of the position of the first code within the sequence of codes. For instance, the identifier of the first code may be stored as an index associated with the first code within the sequence of codes. In addition, the tag device may initialise a counter, in the second memory portion, for most-recently received validated code (in this case the first code).

Since a subsequence of n consecutive codes from the sequence have not yet been detected by the tag device, the tag device refrains from backscattering information responsive to receipt of the first activation signal. The tag device TD1, TD2, TD3 may then wait for a subsequent activation signal in operation 2-5a.

In operation 2-6, having received a subsequent (or second) activation signal A2 from the activator device AD1, the tag device TD1, TD2, TD3 may start charging using the charging portion of the second activation signal A2. Having harvested sufficient energy from the second activation signal A2, the tag device TD1, TD2, TD3 detects the code in the second security portion of the second activation signal A2.

In operation 2-7, the tag device TD1, TD2, TD3 validates the code from the second activation signal A2. This may include determining whether the detected code is present in the sequence of codes stored at the tag device TD1, TD2, TD3. It may also include determining that the detected code has not been impermissibly reused, similarly to as described with reference to operation 2-4.

If, in operation 2-7, the code from the second activation signal A2 is validated, the tag device may proceed to operation 2-8. If, in operation 2-7, the code from the second activation signal is not validated (e.g. because it is not present in the sequence of codes or because it has been impermissibly re-used), the tag device may disregard the code from the second activation signal and proceed to operation 2-12b in which it refrains from backscattering.

In operation 2-8, the tag device TD1, TD2, TD3 determines whether the code detected in the second activation signal is consecutive with (i.e. immediately follows in the sequence) the previously-received code, the identifier of which is stored in the first memory. As will be appreciated, by considering only whether n most recently received codes are consecutive in the sequence, the tag device does not need prior knowledge of the current position in the code sequence. In this way, the need for synchronisation between the tag device and the activator device AD1 may be avoided.

If it is determined that the code detected in the second activation signal is consecutive with the previously detected code, the tag device TD1, TD2, TD3 proceeds to operation 2-10 (or to operation 2-11 and then operation 2-10). If, however, it is determined that the code detected in the second activation signal is not consecutive with the previously detected code, the tag device TD1, TD2, TD3 may proceed to operation 2-9.

In operation 2-9, the tag device stores an indication (e.g. the index in the sequence) of the code detected in the second activation signal in the first memory portion. However, the device refrains from backscattering information (2-12b) and returns to operation 2-5a.

In operation 2-10, the tag device stores an indication (e.g. the index in the sequence) of the code detected in the second activation signal in the first memory portion. Further, because it was determined that the code detected in the second activation signal is consecutive with the previously detected code, the tag device (in operation 2-11) backscatters information. The device then returns to operation 2-5a.

If a subsequent (e.g. third) activation signal is received and it is determined in operation 2-7 that the code carried therein is successfully validated and, in operation 2-8, that it is consecutive with the most-recently received code identified in the first memory portion (in this case the second code), the tag device may again backscatter information in operation 2-11. If, however, the code detected in the third activation signal is validated but is determined not to be consecutive with the most-recently received code indicated in the first memory portion, the tag device may proceed to operation 2.9 and will refrain from backscattering information. The tag device may then backscatter again if the next activation signal carries a code that is consecutive in the sequence with the code in detected in the third activation signal. Thus, it will be appreciated that the activator device may not necessarily transmit all the codes in sequence. Instead, it may, for instance, transmit pairs of consecutive codes from the sequence (in consecutive pairs of activation signals), but those pairs may not be consecutive to one another. The order in which the codes are transmitted may be dictated by the SCE depending what the SCE is trying to achieve. It will also be appreciated that the transmitted codes may not necessarily start at the beginning of the sequence. That is the first-transmitted code is not necessarily the first code in the sequence. In some examples, the tag device may have more information for transmission than can be provided via a single backscattering. In such examples, a first backscattering (e.g. responsive to receiving and validating the first and second codes) may include a first portion of the information related to the tag device and then a second, e.g., different, portion of information related to the tag device may be backscattered in a second backscattering, for instance when the third code, that is consecutive with the second code, is received. In this way, the tag device may be able to transmit all its information, which may be received at the reader device within a relatively short duration.

In other examples, the tag may require a different (and non-overlapping) pair of codes for each backscattering. For instance, instead of updating the first memory portion (in operation 2-10) following a positive determination in operation 2-8, the tag device may clear the first memory portion, though it will still backscatter information in operation 2-11. Thus, the next time an activation signal is received, the tag device will not backscatter information, because there is no code identifier stored in the first memory portion against which to compare the currently-detected code. It may however backscatter responsive to the next activation signal that it receives (assuming positive determinations are reached in 2-7 and 2-8). In yet other examples, the first memory portion may be cleared between bursts of activation signals. For instance, when the tag device becomes inactive at the end of a burst, the first memory portion may be cleared such that, when the next burst of activation signals is received, at least two activation signals from that burst may be received before the device will backscatter.

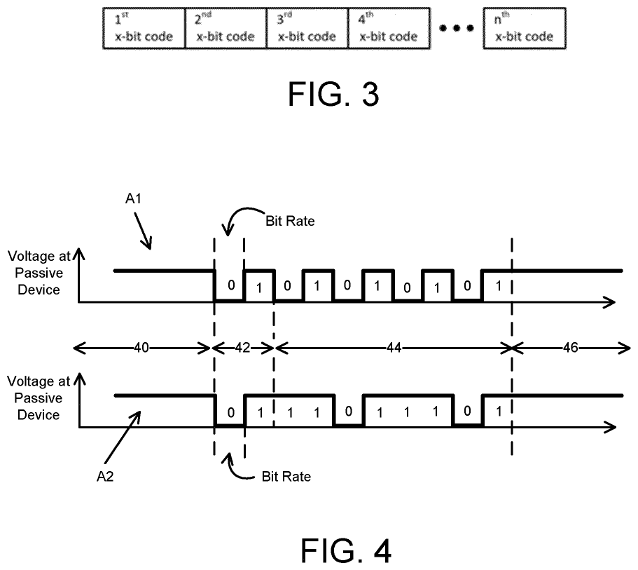

FIG. 3 depicts an example of a sequence of codes which may be stored (or hard-coded) in the tag devices TD1, TD2, TD3. In the example of FIG. 3, the sequence of codes is a sequence of x-bit codes. That is, each code in the sequence, is x bits in length. Put another way, the sequence may comprise a plurality of individual x-bit code sections, which may be referred to as unique code sections (UCS).

The number of possible codes depends on the number of bits utilised for each section. The length (number of bits) of the code may, therefore, determine the strength/security level of the coding scheme. Specifically, a longer code length may be used for applications where security is important, but this may result in an increased the amount of required storage in the tag device. However, where security is less important, a shorter code length may be used. For instance, when the technique is being utilised primarily for selectively activating particular tag devices or groups of tag devices, shorter code length may be used.

In order to selectively activate particular tag devices or groups of tag devices, different tag devices may store different sequences of codes. For instance, one group may store a first sequence of codes and the second group may store a different sequence of codes. The sequences may be configured such that any given adjacent pair of codes will be present in only one of the sequences. In some examples, the first and second sequences of codes may include one or more common codes but, in such examples, the order of those codes in the sequence is different. The session control entity SCE or the activator device AD1 may then download the particular plurality of codes that is stored in the specific tag or group of tags that is to be activated. In other examples, the code sequences could also be configured with portions that will activate more than one group and portions that will only active a one group. That is, two different sequences may include one or more sub-sequences that are common to both sequences and other sub-sequences that are not present in the other sequence.

A 4-bit UCS allows sixteen different codes. This may, for instance, be sufficient for activation of particular devices or groups of devices as all 16 different codes can be used. An 8-bit UCS allows 256 different codes. This may, for instance, be appropriate for higher security applications.

The coding scheme described herein is not 100% unbreakable. For instance, an eavesdropper may, over time, be able to guess the used sequence of the codes. However, as the activator device AD1 only sends one code per activation signal, it will take an eavesdropper some time to guess the used sequences. The security level can be increased by using longer codes (i.e. more bits for each code). For instance, a 10-bit code may allow 1024 different codes, a 15-bit code may allow for 32768 different codes & a 20-bit code allows 1048580 different codes). In addition, by utilising different sequences of codes concurrently and e.g. alternating between sending codes from the different pluralities, it may be more difficult for the eavesdropper to guess a given sequence of codes. In addition, omitting some of the possible codes from a given sequence of codes may also increase the security level. For instance, in the 4-bit implementation, rather than using all 16 available codes, only 12 of the available codes may be used in the sequence.

If the activator device AD1 transmits one activation signal per second, each with a new code, then it will still take an eavesdropper more than 9 hours to derive the full code sequence using 15-bit code, more than 12 days for 20-bit code and more than 1 year for 25-Bit code. The activator device AD1 may, for example, send 5 to 10 UCSs quickly in a burst and then wait 5 to 10 seconds, before the next burst, which will give an average of approximately one UCS per second. As will be appreciated, the more frequently codes are transmitted, the more quickly the entire sequence will be transmitted.

As noted above, the tag devices may store an indication of the most recently-received code from the sequence of codes. This may be an index of the code denoting a position of the code within the plurality (or sequence). The memory, e.g. EEPROM, required to store the index may be dependent on the length of the codes. For instance, 1 kB may be utilised to store the index for a sequence of all possible 13-bit codes.

As described above, one or more counters may also be employed by the tag device to determine whether or not a code has been impermissibly reused. As described above, a respective counter may be provided for each code in the sequences, and so the memory portion which stores the counters may therefore be 1 kB for a complete sequence of 13-bit codes. Or, as also discussed above, a respective counter may be stored for only the Y most recently received codes. For instance, Y could be equal to half the length of the code sequence.

In other examples, determination of impermissible re-use may be performed in other ways. For instance, only a memory portion that stores the index or other identifier of the latest valid code (e.g. the first memory portion) may be employed. Such approaches may be particularly applicable when the codes are transmitted in the predetermined sequence. The approaches may require less memory than other examples described herein but, in some cases, may require some additional computation by the tag device when performing validation. In such approaches, for a newly-received code to be considered valid, it may be required to have a particular positional relationship with the latest valid code identified in the memory portion, where the particular positional relationship is indicative of the newly-received code not having been impermissibly re-used. For instance, the particular positional relationship that is indicative of the newly-received code not having been impermissibly re-used may be that the newly-received code is positioned in the sequence after the latest valid code (but not necessarily immediately after). In another example, the particular positional relationship may that the newly-received code is either positioned in sequence after the latest valid code (but not necessarily immediately after) or is positioned at least a predefined number of places before the latest valid code. In such examples, the tag device may, for each received code, count backwards in the full sequence from the position of the latest valid code to verify that the newly received code is not present in the portion of the full sequence identified by the backward count. The predefined (or count back) number may be known by the tag device and the SCE. If a newly-received code is found not to have the positional relationship with the latest valid code, the newly-received code may be disregarded. If the newly-received code is found to have the positional relationship with the latest valid code, the memory portion may be updated to store the identifier of the newly-received code. In addition, if the latest valid code and the newly-received code are consecutive in the sequence, backscattering may be performed. In the above examples, the latest valid code is used for determining whether a newly received code has been impermissibly re-used. However, in other examples, it may be the latest valid code which triggered backscattering that is used.

FIG. 4 is a schematic example of a format of the activation signals A1, A2 that may utilised by the techniques described herein. Specifically, it depicts signals each carrying a different code. The depicted signals may be modulated onto a carrier wave to form the activation signals. The modulation may be performed in any suitable manner that allows the tag devices to detect the codes. The modulation may for instance be phase modulation, amplitude modulation or on-off keying (OOK) modulation.

Each signal comprises a charging portion 40 for charging a recipient device followed by a security portion 44 that is modulated to carry a code for detection by the tag device.

The charging portion 40 may be a continuous carrier wave (CW). The charging portion 40 has duration that is sufficient to allow the tag device to charge-up so as to be able to detect the code and then perform any subsequent actions.

The security portion 44 is a portion of the activation signal which is modulated to carry a code (which may be referred to as a security code). The code may be in the form of a series of zeros and ones. For instance, whilst receiving the security portion, the voltage induced at the tag device may be switched between high and low, thereby conveying the code. For instance, when the voltage is high, this may represent a one, whereas when the voltage is low, this may represent a zero. In the example of FIG. 4, the codes are 8 bits in length but, as discussed above, codes of different length may be utilised depending on the particular application for which the technique is being used.

In the example illustrated in FIG. 4, the activation signals A1, A2 include a synchronisation code portion 42. The synchronisation code portion is between the charging portion 40 and the security portion 44. The synchronisation code portion 42 is modulated to carry an synchronisation code for detection by the tag device.

The synchronisation code is for indicating to the tag device a start of the security portion 44. In addition, the synchronisation code may indicate to the tag device a bit rate associated with the security portion 44. This may reduce the need for any synchronisation between the tag devices TD1, TD2, TD3 and the activator device AD1.

The same synchronisation code may be used in each of the activation signals. The synchronisation code may be any x-bit code that starts with a 0-1 bit toggle or includes a 0-1-0 or a 1-0-1 bit toggled section. This allows the tag device to derive the baud-rate. The synchronisation code may be a code that is not contained in the plurality of codes stored by the tag device.

The synchronisation code is known to the tag devices TD1, TD2, TD3. The tag devices TD1, TD2, TD3 may be configured to start listening for the known synchronisation code as soon as it is sufficiently charged. The end of the synchronisation code portion 42 may be the start of the security portion. Alternatively, there may a predefined duration between the end of the synchronisation code portion and the start of the security portion. Either way, the tag device knows based on detection of the synchronisation code portion, when to expect the security portion.

The tag device may, in some examples, be configured to wait for a pre-determined duration after the tag device is sufficiently charged by the energy of the charging portion of the activation signal before monitoring for the synchronisation code. Being sufficiently charged may be referred to as being “woken up” or activated. In some examples, waiting to monitor for the synchronisation code may comprise disregarding any code portions received in the activation signal before expiry of the pre-determined duration. The pre-determined duration may be pre-defined (e.g. fixed) or may be dependent on the bit-rate and, in some examples, the bit length of the codes. Waiting to monitor for the synchronisation code or disregarding any code portions received in the activation signal before expiry of the pre-determined duration, may reduce occurrences of the situation in which the tag device inadvertently identifies part of one of the codes of the sequence of codes as the synchronisation signal.

As can also be seen in FIG. 4, the activation signals A1, A2 may include a backscatter signal portion 46. The backscatter signal portion 46 follows the security portion 44. The backscatter portion 46 may be a continuous carrier wave (CW). The backscatter portion 46 may provide the tag devices TD1, TD2, TD3 with the energy for backscattering information for detection by the reader device RD, RD2, for instance as described with reference to signal R1 and R2 in FIG. 1 and operation 2-11 in FIG. 2. As described above, the activation signals may be transmitted in bursts. In such examples, the activation signals may be transmitted in such proximity that the charging portion of the second activation signal immediately follows (or is a continuation of) the backscatter portion of the first activation signal.

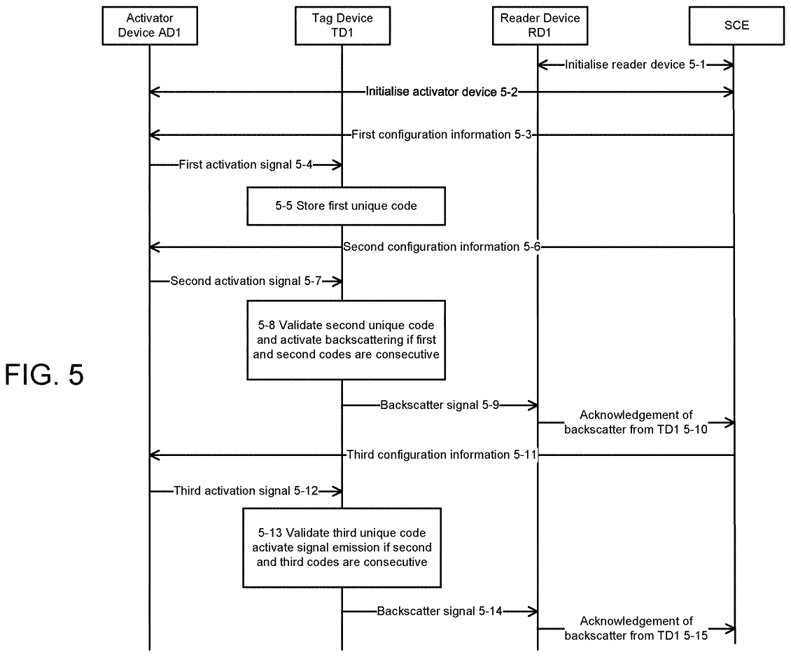

FIG. 5 is an example message flow sequence involving the activator device AD1, one of the tag devices TD1, a reader device RD1, and the session control entity SCE.

In operation 5-1, the session control entity SCE may initialise the reader device RD 1. This may involve indicating to the reader device, the allocated resources associated with the backscatter portion of the activation signals, thereby enabling the reader device to detect the backscatter signals from the tag devices.

In operation 5-2, the session control entity SCE may initialise the activator device AD1. This may involve indicating to the activator device the allocated resources of the activation signal used for the various portions of the activation signals.

In operation 5-3, the session control entity SCE may configure the activator device AD1 with a first code to be included in a first activation signal A1. This may be as described above with reference to FIG. 1, particularly configuration message C1. For instance, a configuration message C1 may be sent to the activator device AD1. This message may include, indicate or otherwise allow the activator device AD1 to determine the first code.

In operation 5-4, the activator device AD1 sends a first activation signal A1 including the first code. The first code may be identified based on information included in the first configuration signal C1.

In operation 5-5, the tag device TD1 stores an indication of the first code. The storing in operation S5-5 may be similar to operation 2-5 described with reference to FIG. 2 and may follow detection of the first code (operation 2-3) and validation of the first code (operation 2-4). As described above in connection with FIG. 2, validation of the first code may additionally include a check to determine that the code has not be impermissibly re-used.

In operation 5-6, the session control entity SCE configures the activator device with a second code. This may be as described above with reference to FIG. 1, particularly configuration message C2. For instance, a second configuration message C2 may be sent to the activator device AD1. This message may include, indicate or otherwise allow the activator device AD1 to determine the second code to be included in the second activation signal. In other examples, however, the first configuration message C1 may configure the activator device with both the first and second codes, and a second configuration message may be omitted.

In operation 5-7, the activator device AD1 sends a second activation signal A2 including the second code.

In operation 5-8, the tag device validates the second code (similarly to as described with reference to operation 2-7) and determines that the first and second codes are consecutive (e.g. as described with reference to operation 2-8). As will be appreciated, operation 5-8 may also include updating the indicator of the most-recently received valid code in the first memory portion, e.g. as described with reference to 2-10.

Responsive to validating the second code and determining that the first and second codes are consecutive in the stored sequence of codes, the tag device, in operation 5-9, backscatters a signal R1 including information related to the tag device.

In operation 5-10, having received the backscattered signal R1, the reader device RD1 indicates to the session control entity SCE, via a message ACK1 (see FIG. 1), that it has received a backscattered signal from the tag device. This message may include some or all of the information received from the tag device.

In operation 5-11, the session control entity SCE configures the activator device AD1 with a third code. This may be as described above with reference to the configuration messages C1 and C2. For instance, a configuration message may be sent to the activator device AD1. This message may include, indicate or otherwise allow the activator device AD1 to determine the third code to be included in the third activation signal. In some examples, operation 5-11 may be performed only if the SCE received the indication ACK1 in operation 5-10. In some examples, the third code may have been indicated to the activator device in the first (or second) configuration message, and so a configuration message specifically for indicating the third code may not be required.

In operation 5-12, the activator device AD1 sends a third activation signal including the third code. This may be substantially as described with reference to operation 5-7.

In operation 5-13, which is similar to operation 5-8, the tag device validates the third code and determines that the second and third codes are consecutive in the stored sequence of codes.

In operation 5-14, responsive to validating the third code and determining that the second and third codes are consecutive in the stored sequence of codes, the tag device backscatters a signal R1 including information related to the tag device.

In operation 5-15, having received the backscattered signal, the reader device RD1 indicates to the SCE, via a message ACK1 (see FIG. 1), that it has received a backscattered signal from the tag device.

As will be appreciated, although it is not shown in FIG. 5, the activator device AD1 may continue to send activation signals. Each time the activator device AD1 sends an activation signal configured for activating the tag device TD1 (or a group of devices including TD1), the activation signal may include a code from the sequence that is stored in the tag device TD1. As noted above, the code in each activation signal may be configured by a respective configuration signal. Alternatively, in some examples, the activator device AD1 may send multiple activation signals for activating the tag device TD1 (or a group of devices including TD1) periodically based on just one configuration message. In some such examples, the SCE may send another configuration message in order to stop the activator device sending activation signals targeting the tag device TD1 (or a group of devices including TD1).

FIG. 5 only shows one tag device TD1. However, as described above, there may be many tag devices in the environment, and these may store different sequences of codes. Thus, it will be appreciated that the session control entity SCE may control the activator device AD1 to send activation signals targeting different groups of devices. For instance, a first activation signal may be sent which includes a first code. This first code may, for instance, be present in the sequence of codes stored by each of multiple devices e.g. TD1 and TD2. Thus, both tag devices TD1, TD2 may store an indication that the first code is the most-recently received valid code. However, the next activation signal sent by the activator device AD1 may include a second code which is the “next code in the sequence” for only one of those devices, e.g. TD1. TD1 would therefore backscatter a responsive signal. TD2, however, would not backscatter. It may however update its first memory portion if the second code is present in its stored sequence of codes. However, the third code included in the third activation signal transmitted by the activator device AD1 may be the “next code in the sequence” for TD2 (i.e. the positional relationship for the first and third codes is met) and so TD2 (but not TD1) would, this time, backscatter a responsive signal. As noted above, by switching between code sequences in this way, it may be more difficult for eavesdroppers to gain knowledge of complete sequences.

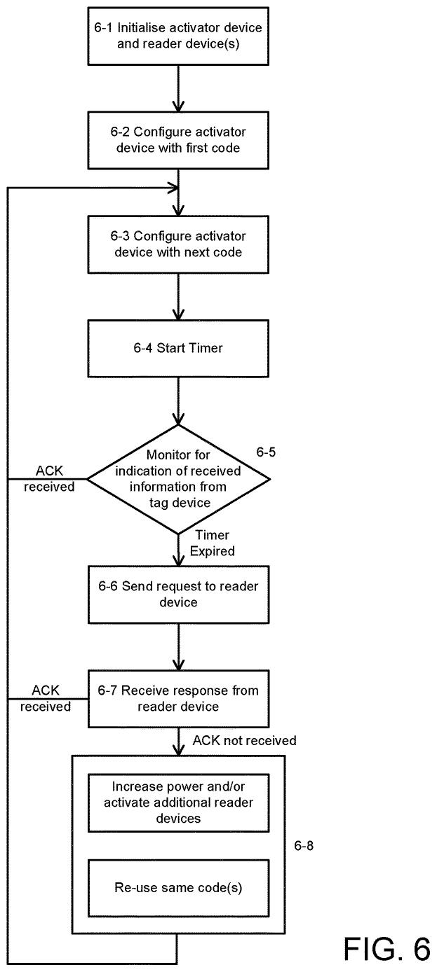

FIG. 6 depicts operations that may be performed by a session control entity SCE in various implementations of the techniques described herein.

In operation 6-1, the session control entity initialises the activator device(s) AD1 and reader device(s) RD1 that will be involved in the session. This may be as described with reference to operations 5-1 and 5-2 of FIG. 5.

In operation 6-2, the session control entity SCE configures the activator device AD1 with a first code to be included in a first activation signal A1. This may be as described above with reference to FIG. 1, particularly configuration message C1, and operation 5-3 of FIG. 5. For instance, a configuration message C1 may be sent to the activator device AD1. This message may include, indicate or otherwise allow the activator device AD1 to determine the first code. The message may be transmitted via any suitable transmission mechanism (e.g. in a high layer protocol such as via a MAC-control element or low layer procedure such as Downlink Control Information).

In operation 6-3, the session control entity SCE configures the activator device AD1 with the next code in the sequence of codes. This may be as described above with reference to FIG. 1, particularly configuration message C2, and operation 5-6 of FIG. 5. For instance, a configuration message C2 may be sent to the activator device AD1. This configuration message may include, indicate or otherwise allow the activator device AD1 to determine the second code that is to be included in the activation signal. The message may be transmitted via any suitable transmission mechanism, e.g via MAC CE or DCI. In other examples, however, only a single configuration message may be transmitted in operation 6-2, which indicates both the first and second codes. It may for instance indicate the entire sequence, or a portion of the sequence which includes the first and second codes. Thus, operation 6-3 may be omitted.

In operation 6-4, the session control entity SCE starts a timer. The timer is for use in determining when the session control entity should take action in the event that no information is received from a tag device that the session control entity is intending to activate (this may be referred to as the target TD). The timer may be started after configuring the activator device in operation 6-3 or after configuring the configuring the activator device in operation 6-2.

In operation 6-5, the session control entity monitors for incoming indications confirming that information has been received from the target TD. Such an indication may be provided to the session control entity by the reader device RD1 upon detecting a signal backscattered by the target TD.

If the session control entity SCE receives an indication from the reader device confirming that information has been received from the target TD, the session control entity may return to operation 6-3 (or 6-2) in which the session control entity SCE configures the activator device AD1 with another code in the sequence of codes (or another subsequence of the sequence of codes).

If, however, the session control entity SCE has not received an indication from the reader device confirming that information has been received from the target TD and the timer started in operation 6-4 expires, the session control entity SCE may proceed to operation 6-6.

In operation 6-6, the session control entity SCE may send a request to the reader device RD1 asking for confirmation as to whether the reader device RD1 has received information from the target TD.

In operation 6-7, the session control entity receives a response from the reader device RD1. If the response indicates that the reader device RD1 has received information from the target TD, the session control entity may return to operation 6-3 (or 6-2) in which the session control entity SCE configures the activator device AD1 with another code (or another subsequence of the sequence of codes) in the sequence of codes. If, however, the response indicates that the reader device RD1 has not received information from the target TD, the session control entity may, in some examples, perform operation 6-8.

In operation 6-8, the session control entity SCE may configure the activator device AD1 to increase the power at which activation signals are sent. By increasing the power, it is more likely that the activation signals will be received by the target TD and that any signals backscattered by the target TD will have sufficient power to be detected by the reader devices. Such configuration may be performed by way of one or more configuration messages.

In addition to, or instead of, increasing the power at which activation signals are sent, the session control entity SCE may activate one or more additional reader devices and/or activator device in the environment. This may be achieved via an initialisation message sent to an additional reader device RD1 or activator device. By increasing the number of active reader devices and/or activator devices, the likelihood that a backscatter signal is received from the target TD may be increased.

As well as configuring the activator device AD1 to increase the power at which activation signals are sent and/or activating one or more additional reader and/or activator devices, the session control entity SCE may configure the activator device to re-send one or more activation signals with the previously sent code(s). If no information has ever been received from a given target TD, the session control entity SCE may cause the activator device to re-send two activation signals with the two most-recently sent codes (e.g. the first code and the second code). However, if information has been previously received from the target TD, the session control entity SCE may cause the activator device to re-send only the most recent activation signals with the most-recently sent code. This is because, since information has been received previously, the SCE knows that code prior the most recently sent was received by the target TD.

In other examples, the session control entity may configure the activator device to re-send one or more activation signals with the same code(s), without increasing the power or activating additional readers. In yet other examples, the session control entity may configure the activator device to send one or more activation signals with new code(s).

After the configuring the activator device in operation 6-8, the session control entity may return to operation 6-5 in which it monitors for incoming indications confirming that information has been received from the target TD.

As discussed above, the SCE may configure the activator device to transmit codes from a number different sequences, thereby to selectively elicit responses from different tag devices (or groups of tag devices). For instance, in a first iteration of operation 6-2 (and in some examples 6-3), the SCE may configure the activator device to send codes from a first sequence. Then, in a later iteration of operation 6-2 (and in some examples 6-3), the SCE may configure the activator device to send codes from a second, different sequence.

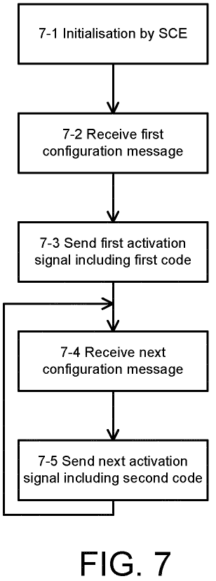

FIG. 7 depicts operations that may be performed by an activator device AD1 in various implementations of the techniques described herein.

In operation 7-1, the activator device AD1 is initialised by the session control entity SCE. This may be as described with reference to operation 5-2 of FIG. 5. In examples in which the activator device is also the reader device, the activator device AD1 may also be configured as a reader device as described with reference to operation 5-2 of FIG. 5.

In operation 7-2, the activator device AD1 is configured by the session control entity SCE with a first code to be included in a first activation signal A1. For instance, the activator device may receive a configuration message from the session control entity. This may be as described above with reference to FIG. 1, particularly configuration message C1, and operation 5-3 of FIG. 5.

In operation 7-3, the activator device AD1 transmits a first activation signal. The first activation signal comprises a first charging portion for charging a tag device, a first backscatter portion and a first security portion, that is modulated to carry the first code for detection by the tag device, between the charging portion and the backscatter portion. The first activation signal may be as described with reference the other FIGs, not least FIG. 4.

In operation 7-4, the activator device AD1 is configured by the session control entity with a next code to be included in a second activation signal A2. For instance, the activator device may receive a second configuration message from the session control entity. This may be as described above with reference to FIG. 1, particularly configuration message C2, and operation 5-6 of FIG. 5. In some examples, the next code may have been indicated to the tag device along with the first code, and so operation 7-4 may be omitted.

In operation 7-5, the activator device AD1 transmits a next (in this case, second) activation signal. The second activation signal comprises a second charging portion for charging a tag device, a second backscatter portion and a second security portion, that is modulated to carry the second code for detection by the tag device, between the second charging portion and the second backscatter portion. The second activation signal may be as described with reference the other FIGs, not least FIG. 4.

As illustrated in FIG. 7, the activator device AD1 may then return to operation 7-4 in which it receives from the session control entity subsequent configuration messages indicating subsequent codes and transmits these in subsequent activation signals.

As will of course be appreciated, the activator device AD1 may be configured to perform any of the operations described herein with respect to the activator device AD1. For instance, it may receive a configuration message from the SCE which causes the SCE to increase the power at which it transmits the activation signals.

### Example Configurations of Apparatuses

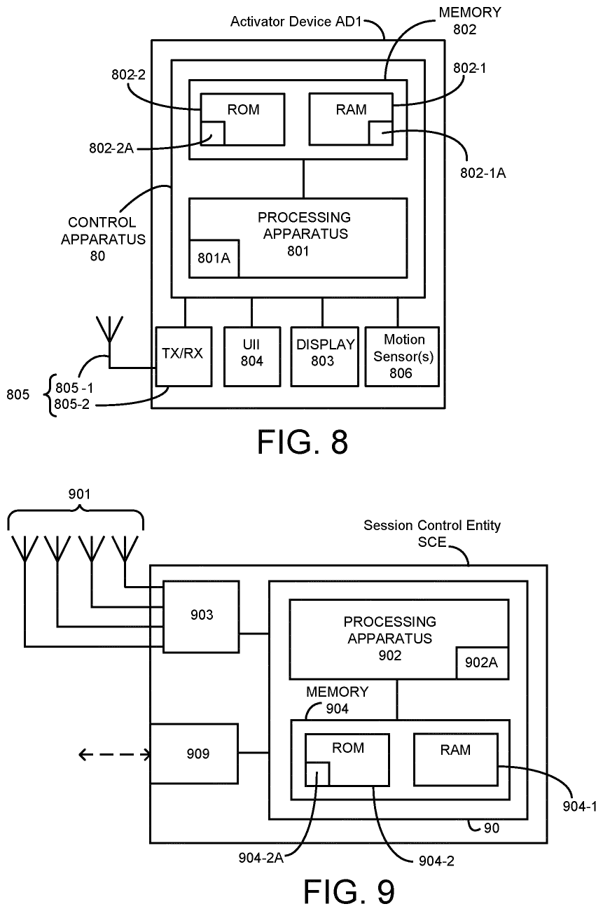

FIG. 8 is a schematic illustration of an example configuration of an activator device AD1 which may be configured to perform various operations described with reference to FIGS. 1 to 7.

The activator device AD1 may transmit activation signals via a radio interface arrangement 805. The radio interface arrangement 805 may be provided for example by means of a radio part 805-2 (e.g. a transceiver) and an associated antenna arrangement 805-1. The antenna arrangement 805-1 may be arranged internally or externally to the activator device AD1.

As described above, the activator device AD1 may additionally communicate with the session control entity SCE (e.g. to receive configuration messages). Such communication may be via any suitable interface, for instance the radio interface arrangement 805 or any other wired or wireless interface.

The activator device AD1 comprises a controller/control (or processing) apparatus 80 which is operable to control the other components of the activator device AD1 in addition to performing any suitable combinations of the operations described in connection with activator device AD1 with reference to the preceding FIGS. The control apparatus 80 may comprise processing apparatus 801 and memory 802. Computer-readable code 802-2A may be stored on the memory 802, which when executed by the processing apparatus 801, causes the control apparatus 80 to perform any of the operations described herein in relation to the activator device AD1. Also, the memory 802 may include a transmission buffer 802-1B.

Example configurations of the memory 802 and processing apparatus 801 will be discussed in more detail below

The activator device AD1 may be, for example, a device that does not need human interaction, such as an entity that is involved in Machine Type Communications (MTC). Alternatively, the activator device AD1 may be a device designed for tasks involving human interaction. Non-limiting examples for the activator device AD1 include a smart phone, a laptop, a smartwatch, a tablet computer, an e-reader, a vehicle-based terminal device, such as those mounted on cars, buses, uncrewed aerial vehicles (UAVs), aeroplanes, trains, or boats, or any type of terminal device that may be carried by a user, or worn on their person.

Where the activator device AD1 is a device designed for human interaction, the user may control the operation of the activator device AD1 by means of a suitable user input interface UII 804 such as key pad, voice commands, touch sensitive screen or pad, combinations thereof or the like. A display 803, a speaker and a microphone may also be provided. Furthermore, the activator device AD1 may comprise appropriate connectors (either wired or wireless) to other devices and/or for connecting external accessories, for example hands-free equipment, thereto. The activator device AD1 may additionally be associated with (e.g. comprises or is in short range wired or wireless communication with) one or a plurality of motion sensors 806 for sensing motion of the activator device. The activator device AD1 may additionally include other sensors such as a GNNS unit.

Although not illustrated herein, it will be appreciated that the reader device(s) may have a similar configuration to the activator device or, as noted above, the reader device functionality may be provided by the activator device.

FIG. 9 is a schematic illustration of an example configuration of a session control entity SCE as described herein. The session control entity SCE is configured for communicating with the activator device AD1 via a wired or wireless interface. The session control entity SCE may comprise a radio frequency antenna array 901 configured to receive and transmit radio frequency signals. Although the session control entity SCE is shown as having an array 901 of four antennas, this is illustrative only. The number of antennas may vary, for instance, from one to many hundreds. As will be appreciated, in some examples the session control entity may communicate with the activator and reader devices via an intermediary such, but not limited to a base station. In some such examples, the session control entity may omit an antenna array and may communicate with the intermediary device via another type of communications interface.

The session control entity SCE may further comprise radio frequency interface circuitry 903 configured to interface between the antenna 901 and a control apparatus 90. The radio frequency interface circuitry 903 may also be known as a transceiver. The session control entity SCE may also or alternatively comprise one or more other interfaces 909 via which it can communicate (e.g. via X2 messages) with other network entities, such as base stations and entities of the core network.

The session control entity control apparatus 90 may be configured to control the other components of the session control entity.

The session control entity control apparatus 90 may comprise processing apparatus 902 and memory 904. Computer-readable code 904-2A may be stored on the memory 904, which when executed by the processing apparatus 902, causes the control apparatus 90 to perform any of the operations assigned session control entity 90 described above.

As should of course be appreciated, the entities shown in each of FIGS. 8 and 9 described above may comprise further elements which are not directly involved with processes and operations in respect which this application is focussed.

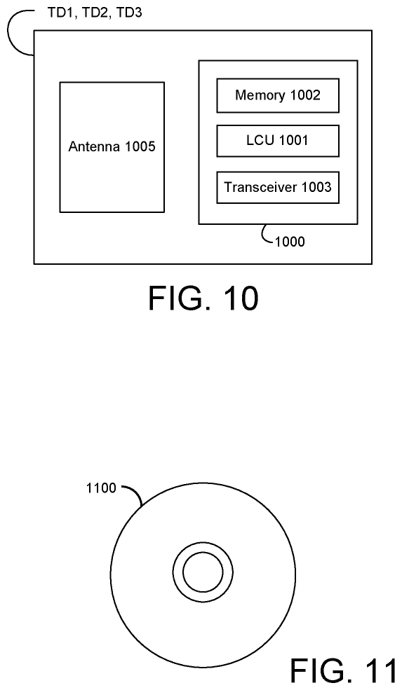

FIG. 10 is a schematic illustration of an example configuration of a tag device described herein. The tag device illustrated in FIG. 10 is batteryless, but it will be appreciated that the techniques described herein are not limited to use with batteryless devices. Instead, in some implementations, the tag device may include some energy storage element.

The tag device TD1, TD2, TD3 of FIG. 1 includes at least an antenna 1005 and control apparatus 1000. The control apparatus 1000 includes processing apparatus 1001 which, in some implementations, may be referred to as a logical control unit (LCU). The control apparatus 1000 includes memory 1002. The memory 1002, which may be of any suitable type, may store the plurality of codes and many include the first and second memory portions. In addition, the memory may store instructions, which when executed by the processing apparatus 1001, may cause performance of any of the operations described herewith with reference to the tag devices. The control apparatus 1000 includes a transceiver to interface between the antenna 1005 and the control apparatus 1000.

Some further details of components and features of the above-described apparatus/entities/apparatuses and alternatives for them will now be described.

The control apparatuses 80, 90, 1000 may comprise processing apparatus 801, 902, 1001 communicatively coupled with memory 802, 904 1002. The memory 802, 904, 1002 has computer readable instructions 802-2A, 904-2A stored thereon which, when executed, causes the control apparatus 80, 90, 1000 to cause performance of various ones of the operations described herein. The control apparatus 80, 90, 1000 may in some instances be referred to, in general terms, as “apparatus”.

The processing apparatus 801, 902, 1001 may be of any suitable composition and may include one or more processors 801A, 902A of any suitable type or suitable combination of types. For example, the processing apparatus 801, 902, 1001 may be a programmable processor that interprets computer program instructions 802-2A, 904-2A and processes data. The processing apparatus 801, 902, 1001 may include plural programmable processors. Alternatively, the processing apparatus 801, 902 may be, for example, programmable hardware with embedded firmware. The processing apparatus 801, 902, 1001 may be termed processing means. The processing apparatus 801, 902, 1001 may alternatively or additionally include one or more Application Specific Integrated Circuits (ASICs). In some instances, processing apparatus 801, 902, 1001 may be referred to as computing apparatus.

The processing apparatus 801, 902, 1001 is coupled to the memory (which may be referred to as one or more storage devices) 802, 904 1002 and is operable to read/write data to/from the memory 802, 904. The memory 802, 904, 1002 may comprise a single memory unit or a plurality of memory units, upon which the computer readable instructions (or code) 802-2A, 904-2A is stored. For example, the memory 802, 904, 1002 may comprise both volatile memory 802-1 and non-volatile memory 802-2. For example, the computer readable instructions/program code 802-2A, 904-2A may be stored in the non-volatile memory 802-2, 904-2 and may be executed by the processing apparatus 801, 902 using the volatile memory 802-1, 904-1 for temporary storage of data or data and instructions. Examples of volatile memory include RAM, DRAM, and SDRAM etc. Examples of non-volatile memory include ROM, PROM, EEPROM, flash memory, optical storage, magnetic storage, etc. The memories in general may be referred to as non-transitory computer readable memory media.

The term ‘memory’, in addition to covering memory comprising both non-volatile memory and volatile memory, may also cover one or more volatile memories only, one or more non-volatile memories only, or one or more volatile memories and one or more non-volatile memories.

The computer readable instructions/program code 802-2A, 904-2A may be pre-programmed into the control apparatus 80, 90, 1000. Alternatively, the computer readable instructions 802-2A, 904-2A may arrive at the control apparatus 80, 90, 1000 via an electromagnetic carrier signal or may be copied from a physical entity 1100 such as a computer program product, a memory device or a record medium such as a CD-ROM or DVD an example of which is illustrated in FIG. 11. The computer readable instructions 802-2A, 904-2A may provide the logic and routines that enables the entities devices/apparatuses to perform the functionality described above. The combination of computer-readable instructions stored on memory (of any of the types described above) may be referred to as a computer program product.

Embodiments of the technology described herein may be implemented in software, hardware, application logic or a combination of software, hardware and application logic. The software, application logic and/or hardware may reside on memory, or any computer media. In an example embodiment, the application logic, software or an instruction set is maintained on any one of various conventional computer-readable media. In the context of this document, a “memory” or “computer-readable medium” may be any media or means that can contain, store, communicate, propagate or transport the instructions for use by or in connection with an instruction execution system, apparatus, or device, such as a computer.

Reference to, where relevant, “computer-readable storage medium”, “computer program product”, “tangibly embodied computer program” etc., or a “processor” or “processing apparatus” etc. should be understood to encompass not only computers having differing architectures such as single/multi-processor architectures and sequencers/parallel architectures, but also specialised circuits such as field programmable gate arrays FPGA, application specify circuits ASIC, signal processing devices and other devices. References to computer program, instructions, code etc. should be understood to express software for a programmable processor firmware such as the programmable content of a hardware device as instructions for a processor or configured or configuration settings for a fixed function device, gate array, programmable logic device, etc.

If desired, the different functions discussed herein may be performed in a different order and/or concurrently with each other. Furthermore, if desired, one or more of the above-described functions may be optional or may be combined. Similarly, it will also be appreciated that flow diagrams described herein are examples only and that various operations depicted therein may be omitted, reordered and or combined.

It will be appreciated that the technologies described herein may utilised with various different types of networks, including but not limited to 5G/NR networks

Although various aspects of the methods and apparatuses described herein are set out in the independent claims, other aspects may comprise other combinations of features from the described embodiments and/or the dependent claims with the features of the independent claims, and not solely the combinations explicitly set out in the claims.

It is also noted herein that while various examples are described above, these descriptions should not be viewed in a limiting sense. Rather, there are several variations and modifications which may be made without departing from the scope of the present invention as defined in the appended claims.

1. A tag device comprising:
means for receiving a series of activation signals, each comprising a charging portion for charging the tag device, a backscatter portion for backscattering by the tag device and a security portion between the charging portion and the backscattering portion modulated to carry a respective code;
means for detecting the codes carried by the activation signals;
means for comparing the detected codes with codes of a predetermined sequence of codes that is stored at the tag device;
means for refraining from backscattering information in response to the activation signals until a subsequence of n consecutive codes from the predetermined sequence of codes has been detected in the series of activation signals, wherein n is at least two; and
means for, in response to a determination that a subsequence of n consecutive codes from the predetermined sequence of codes has been detected in the series of activation signals, backscattering information related to the tag device using the backscatter portion of an activation signal of the series of activation signals in which the nth of the n consecutive codes is detected.

2. The tag device of claim 1, wherein n is equal to two, and wherein the series of activation signals comprises at least a first activation signal and a second activation signal, the tag device comprising:
a first memory portion for storing an identifier of a most-recently detected code that corresponds to a code in the predetermined sequence of codes;
means for, upon receiving the first activation signal and determining that a code detected in the first activation signal corresponds to a first code of the predetermined sequence of codes, storing an identifier of the first code in the first memory portion.

3. The tag device of claim 2, comprising:
means for, upon receiving the second activation signal, examining the first memory portion to determine the identifier stored therein;
means for determining whether a code detected in the second activation signal corresponds to a second code in the predetermined sequence of codes that, in the predetermined sequence of codes, immediately follows the first code, the identifier of which is stored in the first memory portion; and
means for, in response to a determination that the code detected in the second activation signal corresponds to a second code in the predetermined sequence of codes that, in the predetermined sequence of codes, immediately follows the first code, backscattering information related to the tag device using the backscatter portion of the second activation signal.

4. The tag device of claim 3, comprising means for updating the first memory portion to store an identifier of the second code.

5. The tag device of claim 4 comprising:
means for receiving a third activation signal of the series of activation signals;
means for examining the first memory portion to determine the identifier stored therein and determining whether a code detected in the third activation signal corresponds to a third code in the predetermined sequence of codes that, in the predetermined sequence of codes, immediately follows the second code, the identifier of which is stored in the first memory portion; and
means for backscattering information related to the tag device responsive to determining that the code detected in the third activation signal corresponds to a third code in the predetermined sequence of codes that, in the predetermined sequence, immediately follows the second code.

6. The tag device of claim 2, comprising:
means for, upon receiving the second activation signal, examining the first memory portion to determine the identifier stored therein;
means for determining whether a code detected in the second activation signal corresponds to a second code in the predetermined sequence of codes that, in the predetermined sequence, immediately follows the first code, the identifier of which is stored in the first memory portion; and
means for refraining from backscattering information in response to determining that the code detected in the second activation signal does not correspond to a second code in the predetermined sequence of codes that, in the predetermined sequence of codes, immediately follows the first code.

7. The tag device of claim 2, comprising:
means for determining whether the first code is at a position in the predetermined sequence that is after a position of a code that is currently identified in the first memory portion or is at a position in the predetermined sequence that is at least a predefined number of positions before the position of the code that is currently identified in the first memory portion;
means for updating the first memory portion to store the identifier of the first code in response to determining that the first code is at a position in the predetermined sequence that is after the position of the code that is currently identified in the first memory portion or is at a position in the predetermined sequence that is at least the predefined number of positions before the position of the code that is currently identified in the first memory portion; and
means for disregarding the code carried in the first activation signal in response to determining that the first code is not at a position in the predetermined sequence that is after the position of the code that is currently identified in the first memory portion and is not at a position in the predetermined sequence that is at least the predefined number of positions before the position of the code that is currently identified in the first memory portion.

8. The tag device of any of claims 3 to 4 comprising:
a second memory portion for recording, for each of multiple codes in the predetermined sequence of codes, a counter having a value indicating a number of codes from the sequence of codes that have been detected by the tag device since that code was previously detected,
wherein the backscattering of information related to the tag device is performed in response to determining a) that a counter for the second code indicates that the second code has not been previously detected by the tag device, or b) that the value of the counter for the second code is in excess of a predetermined threshold.

9. The tag device of any preceding claim, wherein the activation signals of the series of activation signals include a synchronisation portion between the charging portion and the security portion modulated to carry a synchronisation code, wherein the tag device further comprises means for, in respect of each activation signal:
detecting the synchronisation code, and
detecting a start of the security portion based on detection of the synchronisation code.

10. The tag device of claim 9, comprising:
means for determining, in respect of at least a first activation signal of the series of activation signals, a baud-rate based on the synchronisation code detected in the activation signal; and
means for using the determined baud-rate when detecting the code in the security portion of the activation signal.

11. The tag device of claim 9 comprising:
means for receiving a first activation signal of the series of activations signals; and
means for waiting for a pre-determined duration after the tag device is sufficiently charged by the energy of the charging portion of the first activation signal before monitoring for the synchronisation code carried in the first activation signal.

12. The tag device of claim 9 comprising:
means for receiving a first activation signal of the series of activation signals; and
means for disregarding any codes received in the first activation signal before expiry of a pre-determined duration after the tag device is sufficiently charged by the energy of the charging portion of the first activation signal.

13. An activator device comprising:
means for transmitting at least a first activation signal and a second activation signal,
the first activation signal comprising a first charging portion for charging a tag device, a first backscatter portion for backscattering by the tag device and a first security portion between the first charging portion and the first backscatter portion modulated to carry a first code for detection by the tag device,
the second activation signal comprising a second charging portion for charging the tag device, a second backscatter portion for backscattering by the tag device and a second security portion between the second charging portion and the second backscatter portion modulated to carry a second code for detection by the tag device,
wherein the second code immediately follows the first code in a predetermined sequence of codes that is stored at the tag device.

14. The activator device of claim 13, comprising means for receiving, from a session control entity and prior to transmission of the first activation signal, configuration information indicative of the first and second codes.

15. The activator device of claim 14, wherein the configuration information includes at least a portion of the predetermined sequence of codes which includes the first code and the second code, or the predetermined sequence of codes.

16. The activator device of any of claims 13 to 15, wherein the first activation signal further comprises a first synchronisation portion between the first charging portion and the first security portion, and the second activation signal comprises a second synchronisation portion between the second charging portion and the second security portion, wherein the first synchronisation portion and the second synchronisation portion are each modulated to convey the same synchronisation code for detection by the tag device.

17. A session control entity comprising means for transmitting to an activator device configuration information indicative of:
a first code that is to be modulated on to a first security portion of a first activation signal that is to be transmitted by the activator device to a tag device; and
a second code that is to be modulated on to a second security portion of a second activation signal that is to be transmitted by the activator device to the tag device,
wherein the second code immediately follows the first code in a predetermined sequence of codes that is stored at the tag device.

18. The session control entity of claim 17, comprising:
means for determining that an acknowledgment timer has expired prior to receipt by the session control entity of an acknowledgement that a backscattered signal has been received from the tag device; and
means for transmitting to the activator device, in response to a determination that the acknowledgment timer has expired prior to receipt by the session control entity of an acknowledgement that the backscattered signal has been received from the tag device, a message which indicates that the first code is to be carried in a third security portion of a third activation signal that is to be transmitted by the activator device to the tag device.

19. The session control entity of claim 17 or 18, comprising:
means for determining that an acknowledgment timer has expired prior to receipt by the session control entity of an acknowledgement that a backscattered signal has been received from the tag device; and
means for transmitting to the activator device, in response to a determination that the acknowledgment timer has expired prior to receipt by the session control entity of an acknowledgement that a backscattered signal has been received from the tag device, a message which indicates that the activator device should increase a power at which one or more subsequent activation signals are transmitted.

20. The session control entity of any of claims 17 to 19, comprising:
means for determining that an acknowledgment timer has expired prior to receipt by the session control entity of an acknowledgement that a backscattered signal was received from the tag device; and
means for activating an additional reader device configured to detect signals backscattered by the tag device and/or for activating an additional activator device configured to transmit activation signals for detection by the tag device.

21. A method comprising:
receiving, at a tag device, a series of activation signals, each comprising a charging portion for charging the tag device, a backscatter portion for backscattering by the tag device and a security portion between the charging portion and the backscattering portion modulated to carry a respective code;
detecting, by the tag device, the codes carried by the activation signals;
comparing, by the tag device, the detected codes with codes of a predetermined sequence of codes that is stored at the tag device;
refraining, by the tag device, from backscattering information in response to the activation signals until a subsequence of n consecutive codes from the predetermined sequence of codes has been detected in the series of activation signals, wherein n is at least two; and
in response to a determination that a subsequence of n consecutive codes from the predetermined sequence of codes has been detected in the series of activation signals, backscattering, by the tag device, information related to the tag device using the backscatter portion of an activation signal of the series of activation signals in which the nth of the n consecutive codes is detected.

22. A method comprising:
transmitting, by an activator device, at least a first activation signal and a second activation signal,
the first activation signal comprising a first charging portion for charging a tag device, a first backscatter portion for backscattering by the tag device and a first security portion between the first charging portion and the first backscatter portion modulated to carry a first code for detection by the tag device,
the second activation signal comprising a second charging portion for charging the tag device, a second backscatter portion for backscattering by the tag device and a second security portion between the second charging portion and the second backscatter portion modulated to carry a second code for detection by the tag device,
wherein the second code immediately follows the first code in a predetermined sequence of codes that is stored at the tag device.

23. A method comprising:
transmitting, by a session control entity and to an activator device, configuration information indicative of:
a first code that is to be modulated on to a first security portion of a first activation signal that is to be transmitted by the activator device to a tag device; and
a second code that is to be modulated on to a second security portion of a second activation signal that is to be transmitted by the activator device to the tag device,
wherein the second code immediately follows the first code in a predetermined sequence of codes that is stored at the tag device.
